(19) United States
(12) Patent Application Publication
(10) Pub. No.: US 2018/0284712 A1
(43) Pub. Date: Oct. 4, 2018

(54) INTEGRATED SERVICES PLATFORM

(71) Applicant: Accenture Global Solutions Limited, Dublin (IE)

(72) Inventors: Amit Mathur, Gurgaon (IN); RaeAnn Louise Johnson Hancock, Virginia Beach, VA (US); Sneh Srivastava, Gurgaon (IN)

(21) Appl. No.: 15/684,629

(22) Filed: Aug. 23, 2017

(30) Foreign Application Priority Data
Mar. 28, 2017 (IN) 201741010933

(51) Int. Cl. G05B 19/042

(52) U.S. Cl. CPC G05B 19/0428; G05B 2219/25045

(57) ABSTRACT

Implementations directed to providing a computer-implemented integrated services platform include actions of providing a central repository storing a plurality of computer-readable process models, each process model defining at least one process specific to a respective industry, and one or more computer-implemented assets for executing the at least one process, receiving user input including one or more parameters, the user input being received through a process model navigation portal of the integrated services platform, retrieving one or more process models from the central repository, each of the one or more process models being responsive to the one or more parameters, receiving user selection of a process model of the one or more process models, and delivering one or more computer-implemented services based on the process model using a delivery portal, the one or more services being accessed by end users through a multi-layer architecture of the integrated services platform.

### CROSS-REFERENCE TO RELATED APPLICATION

This application claims priority to Indian Provisional Patent Application No. 201741010933, filed on Mar. 28, 2017, entitled “INTEGRATED SERVICES PLATFORM,” the entirety of which is hereby incorporated by reference.

### BACKGROUND

Process models can be used to develop and deploy services used by enterprises. In some services and underlying process models are developed on a case-by-case basis. This results in numerous inefficiencies. For example, non-standard architectures, redundancy in activities, lack of ability to scale services, redundancy of assets stored in computer-readable memory, and lack of end-to-end support for services. More generally speaking, process models and content are spread out, and stand-alone, preventing a seamless and connected view of enterprises at the end-to-end operating level. Further, reuse of the content and process models is difficult.

### SUMMARY

Implementations of the present disclosure are generally directed to a computer-implemented integrated services platform.

In some implementations, actions include providing a central repository storing a plurality of computer-readable process models, each process model defining at least one process specific to a respective industry, and one or more computer-implemented assets for executing the at least one process, receiving user input including one or more parameters, the user input being received through a process model navigation portal of the integrated services platform, retrieving one or more process models from the central repository, each of the one or more process models being responsive to the one or more parameters, receiving user selection of a process model of the one or more process models, and delivering one or more computer-implemented services based on the process model using a delivery portal, the one or more services being accessed by end users through a multi-layer architecture of the integrated services platform. Other implementations of this aspect include corresponding systems, apparatus, and computer programs, configured to perform the actions of the methods, encoded on computer storage devices.

These and other implementations can each optionally include one or more of the following features: the multi-layer architecture includes an interface layer, a service layer, an enterprise layer, and a data access layer; the services layer securely exposes data provided from the enterprise layer for communication to the interface layer, the enterprise layer extracting process model data of the process model, transforming the data of the process model into one or more required formats, and the data access layer providing logic for extracting data from the central repository using queries and/or stored procedures; the process model navigation portal interacts with a plurality of components comprising at least the delivery portal, and one or more of a solutions board, a capability assessment model (CAM) diagnostics tool, a process segmentation tool, a horizon navigation tool, an application assessment tool, and a time distribution survey tool; one or more process model images are published to a shared library of the integrated services platform, the shared library enabling users to search available process models stored in the central repository; at least one process model is edited based on user edits received through a process modeling platform of the integrated services platform; and each service is associated with a computer-stored service definition that is provided through a central services portal of the integrated services platform.

Implementations of the present disclosure provide one or more of the following example advantages. In general, the integrated services platform of the present disclosure seamlessly integrates computer-based assets to enable creation of scenarios in support various stages of sales, solution, and delivery of computer-implemented services. Further, implementations provide more efficient access to resources using, for example, a single sign-on for enterprise users, efficient searching and retrieval of stored assets. Further, asset maintenance is supported by version control, and a robust backend system is provided to model the assets.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example architecture in accordance with implementations of the present disclosure.

FIG. 2 depicts an example conceptual architecture of the integrated services platform of the present disclosure.

FIG. 3 depicts an example schematic architecture of the integrated services platform in accordance with implementations of the present disclosure.

FIG. 4 depicts an example layer architecture of the integrated services platform in accordance with implementations of the present disclosure.

FIG. 5 depicts an example process that can be executed in implementations of the present disclosure.

### DETAILED DESCRIPTION

Implementations of the present disclosure are generally directed to a computer-implemented integrated services platform that leverages industry-standard process models, and/or reused process models. More particularly, the computer-implemented platform of the present disclosure provides an integrated services platform that enables development and deployment of computer-implemented services to one or more enterprises based on previously developed assets, which can include process models and content. In some implementations, the integrated services platform of the present disclosure enables provision of logically connected, seamless, end-to-end view of a plurality of services, and, for each service providing value-added information, such as underlying technologies, human capital, data models, etc. needed to realize the service, as well as metrics (e.g., key performance indicators (KPIs)) tied to particular processes for evaluating services once delivered (deployed). The integrated services platform of the present disclosure also supports delivery of services.

As described in further detail herein, implementations of the present disclosure can include actions of providing a central repository storing a plurality of computer-readable process models, each process model defining at least one process specific to a respective industry, and one or more computer-implemented assets for executing the at least one process, receiving user input including one or more parameters, the user input being received through a process model navigation portal of the integrated services platform, retrieving one or more process models from the central repository, each of the one or more process models being responsive to the one or more parameters, receiving user selection of a process model of the one or more process models, and delivering one or more computer-implemented services based on the process model using a delivery portal, the one or more services being accessed by end users through a multi-layer architecture of the integrated services platform.

As also described in further detail herein, the integrated services platform of the present disclosure provides a repository of process models (reference process models) and content, and tools enabling users to use the process models and content in new projects. In some examples, two or more process models are logically interlinked to support phases of different projects. In some implementations, the integrated services platform provides one or more of the following features, as described in further detail herein, authentication and authorization of requests, web browser compatibility to support web-based access, mobile device compatibility to enable mobile application-based access, seamless data loading, integration of multiple data sources from two or more external sources spanning different domains, relatively quick performance and page load, role-based access, ability to manage page content that is displayed, tracking and traceability of assets (e.g., process models, content), user profiling, and scalability of the platform to include additional assets. More generally, the integrated services platform of the present disclosure provides a central repository for assets across multiple industries enterprises operate in, and enables various views and assets to be logically and seamlessly connected. The integrated services platform also enables porting of data to various computer-implemented delivery tools, which are used to deliver computer-implemented services to enterprises.

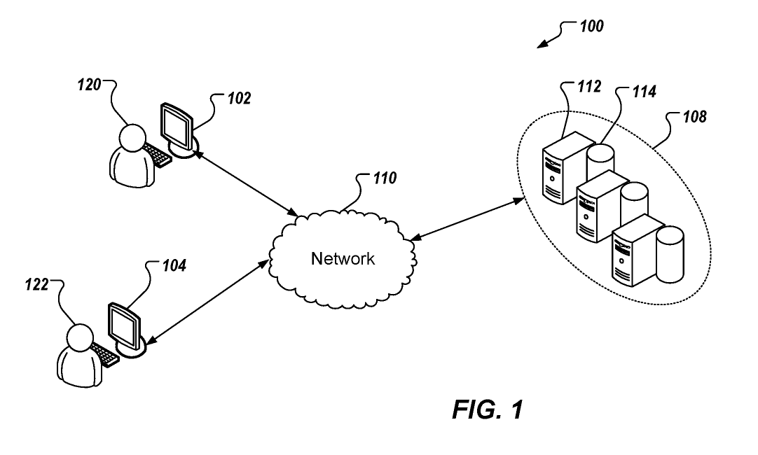

FIG. 1 depicts an example system 100 that can execute implementations of the present disclosure. The example system 100 includes computing devices 102, 104, a back-end system 108, and a network 110. In some examples, the network 110 includes a local area network (LAN), wide area network (WAN), the Internet, or a combination thereof, and connects web sites, devices (e.g., the computing device 102, 104), and back-end systems (e.g., the back-end system 108). In some examples, the network 110 can be accessed over a wired and/or a wireless communications link. For example, mobile computing devices, such as smartphones can utilize a cellular network to access the network 110.

In the depicted example, the back-end system 108 includes at least one server system 112, and data store 114 (e.g., database and knowledge graph structure). In some examples, the at least one server system 112 hosts one or more computer-implemented services that users can interact with using computing devices. For example, the server system 112 can host an integrated services platform in accordance with implementations of the present disclosure. In some examples, the computing devices 102, 104 can each include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In the depicted example, the computing devices 102, 104 are used by users 120, 122, respectively. In accordance with the present disclosure, the users 120, 122 use the computing devices 102, 104 to interact with the integrated services platform of the present disclosure. In some examples, the user 120 can include industry-based users that access the integrated services platform to provide, for example, industry-specific process models (e.g., computer-implemented and -processable models specific to respective industries), service details for respective services, as well as industry-specific process hierarchies, and content. In some examples, the user 122 can include agents of a service provider, which provides process modeling and service delivery services for enterprises (e.g., clients of the service provider). Example users can include service users that access the integrated services platform to conduct process modeling and service delivery activities, and administrator users that conduct maintenance activities on the integrated services platform.

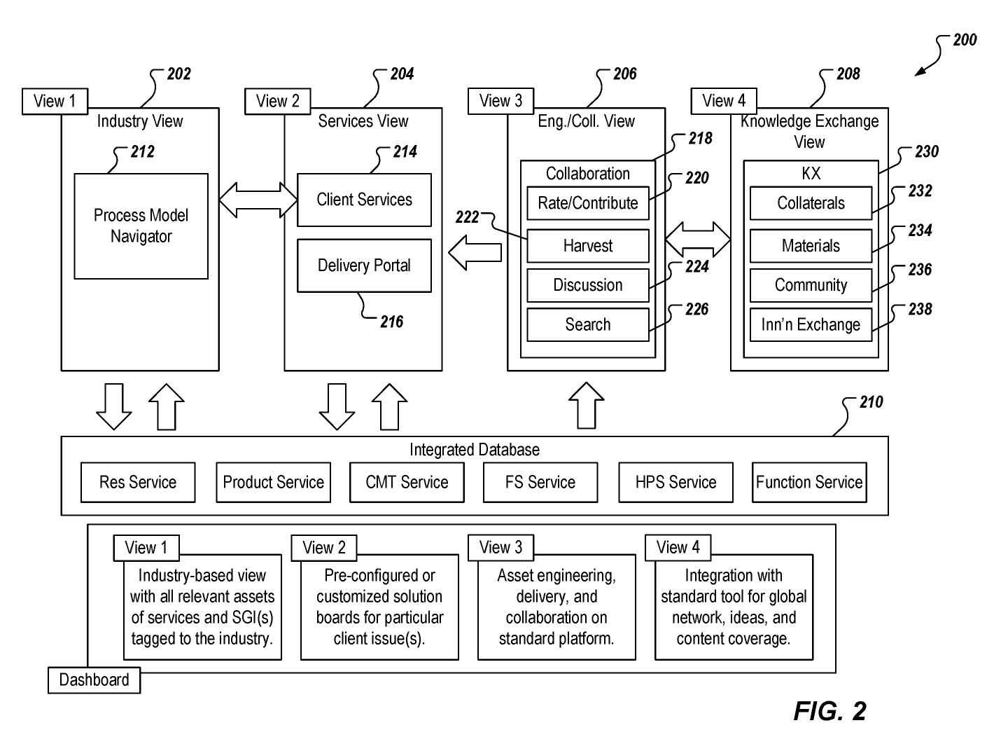

FIG. 2 depicts an example conceptual architecture 200 of the integrated services platform of the present disclosure. In the depicted example, the conceptual architecture 200 includes an industry view component 202, a services view component 204, an engineering and collaboration view component 206, and a knowledge exchange view component 208. In some implementations, one or more of the components 202, 204, 206, 208 interacts with an integrated database system 210. In some examples, the integrated database system 210 stores process models and content across a plurality of services that can be provided to enterprises across a plurality of industries (e.g., product services, financial services (FS) services, communication, media, and technology (CMT) services, health and public safety (HPS) services, and the like).

In some implementations, the industry view component 202 includes a process model navigator (PMN) 212, which enables users to explore process models and content, among other functionality, within an integrated services platform, as described in further detail herein. In some examples, the industry view component 202 provides an industry-based view (e.g., graphically displayed in a user interface (UI)) that depicts industry-relevant assets, performance indicators, and services. In some implementations, the services view component 204 includes a client services sub-component 214, and a delivery portal 216. In some examples, the services view component 204 provides a services-based view (e.g., graphically displayed in a UI) including pre-configured and/or customized solution boards depicting service-based solutions for particular issues, examples of which are described in further detail herein.

In some implementations, the engineering and collaboration view component 206 includes a collaboration sub-component 218, which includes a rate-contribute sub-component 220, a harvest sub-component 222, a discussion sub-component 224, and a search sub-component 226. In some examples, the search sub-component 226 provides integrated search services across all the industries and/or functions, and provides search results based on key words entered (search terms). In this manner, assets can be efficiently searched and retrieved.

In some examples, the engineering and collaboration view component 206 provides an engineering/collaboration-based view (e.g., graphically displayed in a UI) including engineering, delivery, and collaboration content. In some implementations, the knowledge exchange component 208 includes a knowledge exchange (KX) sub-component 230, which includes collaterals sub-component 232, a materials sub-component 234, a community sub-component 236, and an innovation exchange sub-component 238. In some examples, the knowledge exchange component 230 provides a knowledge-based view (e.g., graphically displayed in a UI) providing insight into integration of global network, ideas, and content convergence. In some examples, the views can be presented within a dashboard UI, or any appropriate UI.

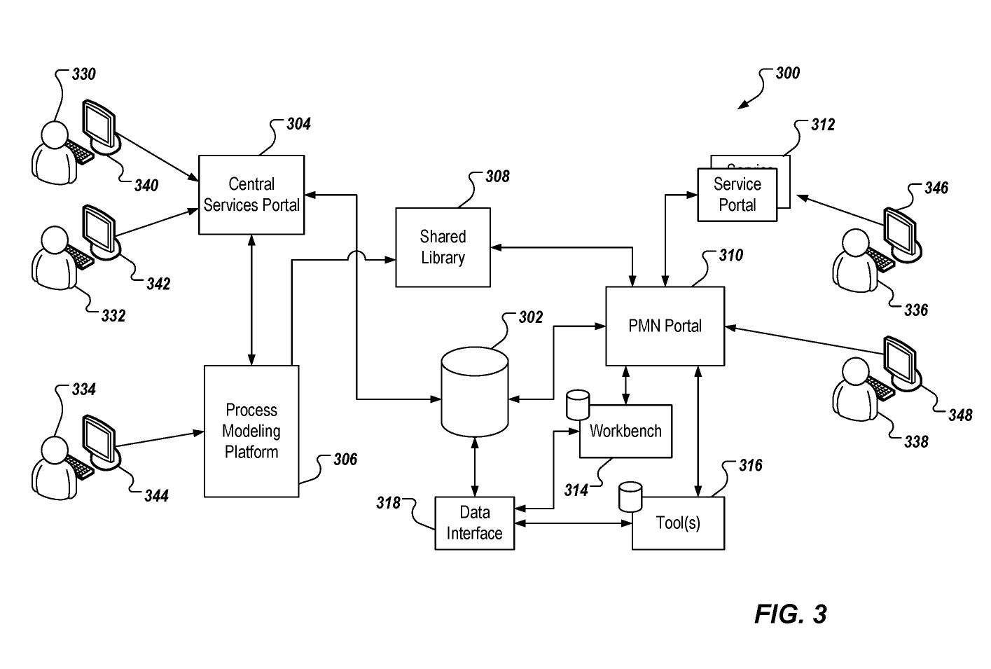

FIG. 3 depicts an example schematic architecture 300 of an integrated services platform in accordance with implementations of the present disclosure. The example schematic architecture 300 includes a central database 302 (e.g., the integrated database system 210 of FIG. 2), a central services portal 304, a process modeling platform 306, a shared library 308, a PMN portal 310, service portals 312, a workbench 314, one or more tools 316, and a data interface 318. In some examples, components, portals, interfaces, libraries, and the like, of the example schematic architecture can each be provided by one or more computer-executable programs executed using one or more computing devices. For example, the example schematic architecture 300 can be hosted on one or more server systems, such as the server systems 112 of the back-end system 108 of FIG. 1.

In some implementations, users 330, 332, 334, 336, 338 interact with the architecture 300 using respective computing devices 340, 342, 344, 346, 348 (e.g., over a network, such as the network 110 of FIG. 1). In some examples, the users 330, 332, 334 include industry-based users (e.g., users 120 of FIG. 1). For example, the user 330 can include an industry-specific services expert, who provides details (e.g., service definitions) of particular services through the central services portal 304, which can be stored in the central database 302. As another example, the user 332 can include an industry-specific process model expert, who provides details (e.g., process hierarchies, assets used in processes) of particular process models through the central services portal 304, which can be stored in the central database 302. As another example, the user 334 can include an industry-specific process modeler, who access the process modeling platform 306 to create and/or edit process models. An example process model can include a core model that provides workflow, functions executed in the workflow, and value diagrams. In some examples, the process models can be described as industry-reference models with package knowledge for reuse in inter- or intra-industry applications to provide computer-implemented automation of processes. In some examples, the process models are stored to the central database 302, and are accessed by other users (e.g., the users 330, 332) through the central services portal 304. In some examples, process model images can be published to the shared library 308 to enable users to search available process models stored in the central database 302.

In some examples, the users 336, 338 include agents of a service provider (e.g., users 122 of FIG. 1). For example, the user 336 can include service portal user, who manages (e.g., creates, edits) service portals, through which enterprises can interact with one or more services. As another example, the user 336 can include a client-service user, who accesses the PMN portal 310 to discover, view, select, etc., services and/or process models of the integrated services platform to provide an end-to-end solution for a respective enterprise based on one or more industries that the enterprise is active in. As another example, the user 338 can include an administrator user, who regulates access to the integrated platform which can include authentication of users (e.g., the user 330, 332, 334, 336), and/or roles of users (e.g., the user 330, 332, 334, 336) within the integrated services platform.

In some implementations, the PMN portal 310 enables users to access process models and/or services stored in the central database 302. In some examples, the PMN portal 310 also enables users to access portals of other applications and/or tools, such as the workbench 314, and the tools 316 (e.g., diagnostic tools, time distribution survey tools, application assessment tools). In general, the PMN portal 310 provides a single access point for views into assets stored in the central database 302, and include multiple tools.

In further detail, the PMN portal 310 improves utilization of process models and content, and enables end-to-end story telling using different, interlinked assets. In some examples, the PMN portal 310 enables download of process models and content to improve leverage in user-facing scenarios. Further, the PMN portal 310 can be used to leverage content from other industries and/or functions. In some examples, the PMN portal 310 functions with a collection of tools, such as a solutions board, a CAM diagnostics tool, a process segmentation tool, a horizon navigation tool, a delivery portal, an application assessment tool, and a time distribution survey tool.

In some examples, the solution board is provided as an interactive, computer-implemented tool that can be used to design visual scripts representative of assets and/or services. For example, the solution board leverages content retrieved through the PMN portal 310, and/or from external sources, to provide graphical representations depicting service-based solutions that address key industry issues. An example workflow for the solution board opening a solution board portal within the PMN portal 310, creating a new solution board, selecting elements (e.g, graphical representations of elements displayed in the portal) that are relevant to a particular enterprise, and adding the elements to an asset cart, and arranging the elements within the solution board, which is subsequently playable to a relevant audience.

In some examples, the delivery portal is a platform (or sub-platform of the integrated services platform) that supports service delivery by providing an enterprise-specific (client-specific) micro-site with relevant assets (e.g., process models, content) in a user-friendly and editable format. In some examples, the delivery portal enables a clear scope of delivery to be defined based on selection of process areas from the PMN portal 310, and initiates delivery by, for example, exporting accelerators in the form of assets associated with the selected process areas. An example workflow for the delivery portal includes defining a scope of delivery based on selection of the process areas, selecting formats (e.g., file formats) for assets to be exported in, instantiating the delivery portal (e.g., provided as a micro-site), enabling user access to the delivery portal (e.g., assigning access rights to relevant users), and populating the delivery portal with assets in the respective, selected formats.

In some examples, the CAM diagnostics tool leverages best-in-class reference CAMs through the PMN portal 310 to create (online or offline) assessments across people, process and technology dimensions, for example. In some examples, the CAM diagnostics tool accelerates the capability assessment phase of the enterprise (client), and provides an efficient process improvement roadmap by reaching out to the correct stakeholders within the enterprise with relevant sets of questions. In some examples, the application assessment tool provides a framework for technology assessment (e.g., IT systems, application available for executing processes based on process models) based on an underlying assessment model. In some examples, the application assessment to helps in assessing the technical and functional fit of one or more applications to an enterprise's technology landscape, accelerates the capability assessment phase of the enterprise, and helps create an efficient application transformation and rationalization roadmap.

In some examples, the time distribution survey tool enables quantitative benchmarking (e.g., process/FTE ratio, time spent on process), and provides a holistic, structured assessment approach across processes to address time management, and identify and interview multiple stakeholders of the enterprise (client). In some examples, the time distribution survey tool provides predefined survey options, a web-based interface, automated reporting, as well as advanced data collection, reporting and analysis. In general, the time distribution survey tool can be used to gauge time management against capabilities of a respective enterprise. In some examples, the process segmentation tool can be used to understand and layout importance priorities for enterprise processes and compare the priorities to a best-in-class view of intervention tasks that can be performed to improve the design and implementation of a process based on the key issues faced by the respective industry. In general, the process segmentation tool helps ensure that the improvement tasks are executed at appropriate points in processes to positively impact value proposition. In some examples, the horizontal navigation tool enables comparison of and views into the processes for two or more industries and/or process segments across a common process segment/theme, and provides seamless navigation of relevant content. In some examples, the horizontal navigation tool enables display and comparison of similar processes across industries, showcases different ways of implementing similar functions across industries/segments, and facilitates showcasing of process expertise breadth along with depth of process models (e.g., reference models), horizontally.

Example assets that can be stored in the central database 302 and accessed using the PMN portal 310 can include models (e.g., industry-reference process models). Example models include, without limitation, logical operating models (LOMs), process hierarchies, process flow models, capability assessment models (CAMs), KPIs, value trees, process impact matrices (PIMs), end-to-end models, application architectures, and organization architectures. In accordance with implementations of the present disclosure, the assets can be leveraged to logically connected, seamless, end-to-end view of one or more model-based services, and, for each service providing value-added information, such as underlying technologies, human capital, data models, etc. needed to deploy the service, as well as metrics (e.g., KPIs) tied to particular processes for evaluating services once deployed. For example, for each process, the integrated services platform can provide an end-to-end view including organization architecture (e.g., human capital to support the process), a process hierarchy, technologies required to implement the process (e.g., application architecture), capability assessment models, KPIs, and a value tree.

In some examples, a LOM provides a simplified view (e.g., single page view) of an enterprise (or portion of an enterprise), as well as a logical breakdown of the operating model based on key processes. In some examples, a LOM supports strategy development, post-merger integration, static analysis summarization, and information technology (IT) strategy design. In some examples, a process hierarchy provides an end-to-end view of a value chain of an enterprise, and can include information for processes of various levels of granularity, describing how the enterprise operates. In some examples, the process hierarchy enables user-friendly process navigation, reuse of value chains, and intelligent maintenance processes. In some examples, a process flow describes the end-to-end, function level tasks for a respective capability, and includes all supporting event, function, data, position, department, systems, rules, and the like, for executing the process. In some examples, the process flow defines an industry-best practice, and enables real-time analysis of the process, as well as supporting process knowledge management, and process reusability.

In some examples, a CAM provides an effective indicator of the robustness, with which processes are defined and executed relative to best-in-class operators. In some examples, a CAM supports more rapid operational diagnostics, competitor assessment, and supports post-merger integration and process reengineering. In some examples, the KPIs are provided as a framework for qualitative capability assessment of processes. For example, KPIs can define parameters that can be monitored for performance assessment, and can be used for benchmarking to provide a foundation for continuous improvement.

In some examples, the value tree is provided as a graphical representation of a hierarchical structure of performance factors of an enterprise, and is representative of value drivers and/or value levers, each of which is linked to particular functionality of a respective process model (e.g., identifying which functions are value drivers/levers). In this manner, a value tree helps develop value realization, supports process improvement, and can be provided as input to a PIM. In some examples, a PIM is a graphical representation that can be used to identify high-impact processes against a set of global macro-economic, industry and client goals during a so-called Diagnose and Explore phase. In some examples, the PIM supports assessments and process improvement, and can be used to define a road map and/or charter development.

In some examples, the end-to-end model digitally represents an end-to-end process and provides a holistic view of a plurality of process segments. The end-to-end model can be graphically represented (e.g., on a display) to enable visualization of the series of activities of particular processes, as provided in respective process model. In some examples, the end-to-end model supports process optimization, provides logical connections between different processes that are interlinked in the end-to-end model, and facilitate value stream mapping.

In some examples, the application architecture provides a structured and logical representation of interconnecting information technology (IT) systems to processes (e.g., as represented by respective process models). In some examples, an application portfolio is provided based on linking applications to the LOM. In some examples, the application architecture can help identify target applications for respective processes, and can be used to streamline application maintenance planning, support change management, and identify process impact on applications. In some examples, the organization architecture provides a hierarchical graphical representation of roles and units within an enterprise, and provides a mapping of roles and/or units to processes (e.g., as represented by respective process models), and/or functions (e.g., of respective process models).

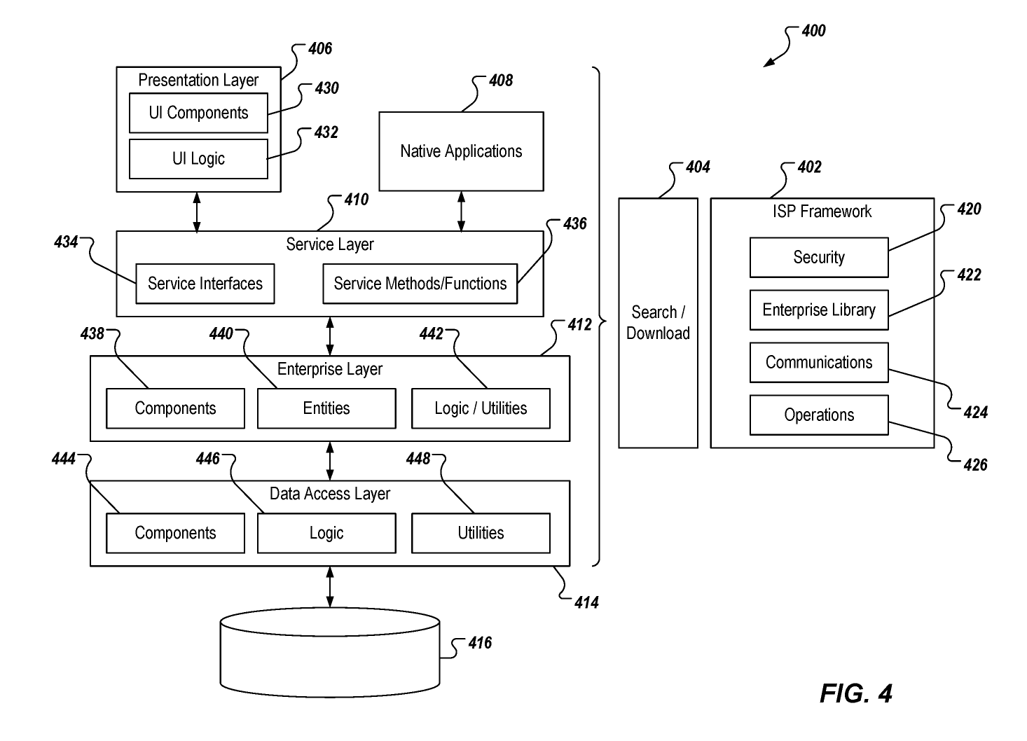

FIG. 4 depicts an example layer architecture 400 of an integrated services platform in accordance with implementations of the present disclosure. The example layer architecture 400 includes an integrated services platform (ISP) framework 402 and search/download functionality 404 that ride over a presentation layer 406, a native applications layer 408, a service layer 410, an enterprise layer 412, a data access layer 414, and a database layer 416. In the depicted example, the ISP framework 402 includes a security component 420, an enterprise library component 422, a communications component 424, and an operations component 426. In some examples, the security component 420 provides security functionality, examples of which can include user authentication (e.g., credential verification), access control (e.g., role-based access control to assets), and encryption/decryption.

In some examples, the enterprise library component 422 provides computer-implemented sub-components, and a set of functional application blocks that provide respective functionality (e.g., data access, logging, validation), and wiring blocks that can be used to provide loosely coupled testable, and maintainable services (e.g., software systems). Example application blocks can include a caching application block (e.g., to provide a cache in a service), a cryptography application block (e.g., to provide hashing and/or symmetric encryption in a service), a data access application block (e.g., used to provide standard database functionality in a service, such as synchronous and asynchronous data access and returning data in a range of formats), an exception handling application block (e.g., to provide for processing of exceptions that can occur throughout the architectural layers of a service), a logging application block (e.g., to provide logging functionality), a policy injection application block (e.g., to enforce interception policies and streamline features, such as logging, caching, exception handling, and validation, across a service), and a security application block (e.g., to provide authorization and security caching functionality in a service). In some examples, the communications component 424 provides computer-implemented communications functionality, which can include, for example, email, instant messaging, and the like. In some examples, the operations component 426 provides computer-implemented operations and batch processing of logic components such as search, indexing, downloads, approval workflows, administrative modules, etc.

In the depicted example, the presentation layer 406 includes UI components 430, and UI component logic 434. In some examples, the presentation layer 406 provides front-end access to one or more services available through the integrated services platform. For example, agents of an enterprise can access and interact with services through the presentation layer 406. In some examples, the presentation layer 406 is representative of web-based access to services, where users access services through web applications having UIs displayed in web browsers executed on client-side computing devices (e.g., the computing device 102 of FIG. 1). In some examples, the UI components include UI elements displayed in a UI that a user can use to interact with a service (e.g., dialog boxes, buttons, menus, etc.). In some examples, the UI component logic 434 can provide functionality that can process user input to a UI component before providing the input to the service layer 410, and/or process output of the service layer 410 before providing to the user in the presentation layer 406.

In some examples, the native application layer 408 is representative native applications that can be used to access services on the service layer 410. Native applications can include, for example, mobile applications that execute on mobile computing devices (e.g., smartphones, tablets), which are specific to respective mobile operating systems. In some examples, each native application includes UIs and logic that support user interaction with the service layer 410.

In general, process modeling data stored in the is extracted, transformed, and uploaded into the central database through enterprising logic. The data again flows through the data access layer 414 (e.g., built on Entity Framework), this data is passed to the enterprise layer 412 to perform specified logic and required secured data is exposed to the UI/Web Applications/Native Application through the service layer 410 (e.g., ODATA/WCF Data Service) and users view the information on the browser (e.g., in the presentation layer 406).

In further detail, the services layer 410 securely exposes the data that comes up from the enterprise layer 412 for communication with UI components (apps, UI layer). In some examples, the services layer 410 implements ODATA/Restful Services/WCF Data Services for the data to be consumed by all the devices on the UI layer through, for example, XML/JSON formats. In some examples, the process modeling data that lies in the database is extracted, and transformed into required formats based on the specific logic that is to be applied with all validations in place. In some examples, there are utilities that define the enterprise logic for validation, and how the data is handled/transformed into the database for adding/modifying/updating the existing data. This also has specific logic to process the data to be sent to the services layer 410. In some examples, the data access layer 410 provides the entire logic of extracting the data from the database using queries/stored procedures or, for example, LINQ queries using the Entity Framework. The data access layer 410 also handles the transactions on the database and the add/modify/update functionalities, as well as passing the data to the enterprise layer 412 (e.g., as per CRUD operation calls made).

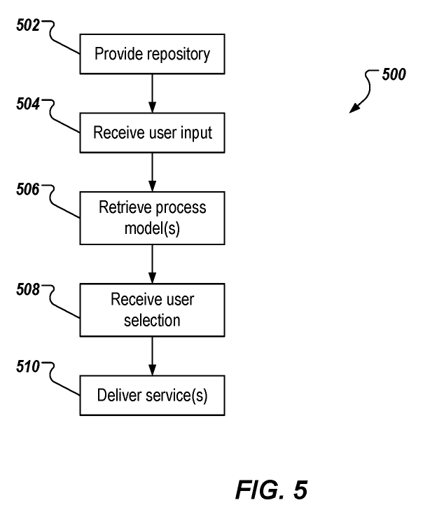

FIG. 5 depicts an example process 500 that can be executed in implementations of the present disclosure. In some examples, the example process 500 is provided using one or more computer-executable programs executed by one or more computing devices (e.g., the back-end system 108 of FIG. 1). The example process 500 can be executed to provide an integrated services platform in accordance with implementations of the present disclosure.

A central repository storing a plurality of computer-readable process models is provided (502). For example, the central database 302 of the architecture 300 of FIG. 3 is provided. In some examples, each process model defines at least one process specific to a respective industry, and one or more computer-implemented assets for executing the at least one process. User input is received (504). In some examples, the user input includes one or more parameters, and is received through a process model navigation portal of the integrated services platform. For example, the user 338 provides user input to the PMN portal 310 through the computing device 348. One or more process models are retrieved from the central repository (506). For example, the PMN portal 310 submits a query to the central repository, the query including at least a portion of the one or more parameters. In some examples, each of the one or more process models is responsive to the one or more parameters. A user selection of a process model of the one or more process models is received (508). For example, respective graphical representations of the one or more process models are displayed to the user 338 on the computing device 348 by the PMN portal 310, and the user selects at least one of the process models. One or more computer-implemented services are delivered based on the process model using a delivery portal (510). In some examples, the one or more services are accessed by end users through a multi-layer architecture of the integrated services platform.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for providing a computer-implemented integrated services platform, the method being executed by one or more processors and comprising:
providing, by the one or more processors, a central repository storing a plurality of computer-readable process models, each process model defining at least one process specific to a respective industry, and one or more computer-implemented assets for executing the at least one process;
receiving, by the one or more processors, user input comprising one or more parameters, the user input being received through a process model navigation portal of the integrated services platform;
retrieving, by the one or more processors, one or more process models from the central repository, each of the one or more process models being responsive to the one or more parameters;
receiving, by the one or more processors, user selection of a process model of the one or more process models; and
delivering, by the one or more processors, one or more computer-implemented services based on the process model using a delivery portal, the one or more services being accessed by end users through a multi-layer architecture of the integrated services platform, the multi-layer architecture comprising an interface layer, a service layer, an enterprise layer, and a data access layer, the services layer securely exposing data provided from the enterprise layer for communication to the interface layer, the enterprise layer extracting process model data of the process model, transforming the data of the process model into one or more required formats, and the data access layer providing logic for extracting data from the central repository using queries and/or stored procedures.

2. The method of claim 1, wherein the process model navigation portal interacts with a plurality of components comprising at least the delivery portal, and one or more of a solutions board, a capability assessment model (CAM) diagnostics tool, a process segmentation tool, a horizon navigation tool, an application assessment tool, and a time distribution survey tool.

3. The method of claim 1, wherein one or more process model images are published to a shared library of the integrated services platform, the shared library enabling users to search available process models stored in the central repository.

4. The method of claim 1, wherein at least one process model is edited based on user edits received through a process modeling platform of the integrated services platform.

5. The method of claim 1, wherein each service is associated with a computer-stored service definition that is provided through a central services portal of the integrated services platform.

6. One or more non-transitory computer-readable storage media coupled to one or more processors and having instructions stored thereon which, when executed by the one or more processors, cause the one or more processors to perform operations for providing a computer-implemented integrated services platform, the operations comprising:
providing a central repository storing a plurality of computer-readable process models, each process model defining at least one process specific to a respective industry, and one or more computer-implemented assets for executing the at least one process;
receiving user input comprising one or more parameters, the user input being received through a process model navigation portal of the integrated services platform;
retrieving one or more process models from the central repository, each of the one or more process models being responsive to the one or more parameters;
receiving user selection of a process model of the one or more process models; and
delivering one or more computer-implemented services based on the process model using a delivery portal, the one or more services being accessed by end users through a multi-layer architecture of the integrated services platform.

7. The computer-readable storage media of claim 6, wherein the multi-layer architecture comprises an interface layer, a service layer, an enterprise layer, and a data access layer.

8. The computer-readable storage media of claim 7, wherein the services layer securely exposes data provided from the enterprise layer for communication to the interface layer, the enterprise layer extracts process model data of the process model, transforms the data of the process model into one or more required formats, and the data access layer provides logic for extracting data from the central repository using queries and/or stored procedures.

9. The computer-readable storage media of claim 6, wherein the process model navigation portal interacts with a plurality of components comprising at least the delivery portal, and one or more of a solutions board, a capability assessment model (CAM) diagnostics tool, a process segmentation tool, a horizon navigation tool, an application assessment tool, and a time distribution survey tool.

10. The computer-readable storage media of claim 6, wherein one or more process model images are published to a shared library of the integrated services platform, the shared library enabling users to search available process models stored in the central repository.

11. The computer-readable storage media of claim 6, wherein at least one process model is edited based on user edits received through a process modeling platform of the integrated services platform.

12. The computer-readable storage media of claim 6, wherein each service is associated with a computer-stored service definition that is provided through a central services portal of the integrated services platform.

13. A system, comprising:
one or more processors; and
a computer-readable storage device coupled to the one or more processors and having instructions stored thereon which, when executed by the one or more processors, cause the one or more processors to perform operations for providing a computer-implemented integrated services platform, the operations comprising:
providing a central repository storing a plurality of computer-readable process models, each process model defining at least one process specific to a respective industry, and one or more computer-implemented assets for executing the at least one process;
receiving user input comprising one or more parameters, the user input being received through a process model navigation portal of the integrated services platform;
retrieving one or more process models from the central repository, each of the one or more process models being responsive to the one or more parameters;
receiving user selection of a process model of the one or more process models; and
delivering one or more computer-implemented services based on the process model using a delivery portal, the one or more services being accessed by end users through a multi-layer architecture of the integrated services platform.

14. The system of claim 13, wherein the multi-layer architecture comprises an interface layer, a service layer, an enterprise layer, and a data access layer.

15. The system of claim 14, wherein the services layer securely exposes data provided from the enterprise layer for communication to the interface layer, the enterprise layer extracts process model data of the process model, transforms the data of the process model into one or more required formats, and the data access layer provides logic for extracting data from the central repository using queries and/or stored procedures.

16. The system of claim 13, wherein the process model navigation portal interacts with a plurality of components comprising at least the delivery portal, and one or more of a solutions board, a capability assessment model (CAM) diagnostics tool, a process segmentation tool, a horizon navigation tool, an application assessment tool, and a time distribution survey tool.

17. The system of claim 13, wherein one or more process model images are published to a shared library of the integrated services platform, the shared library enabling users to search available process models stored in the central repository.

18. The system of claim 13, wherein at least one process model is edited based on user edits received through a process modeling platform of the integrated services platform.

19. The system of claim 13, wherein each service is associated with a computer-stored service definition that is provided through a central services portal of the integrated services platform.
